(19) United States
(12) Patent Application Publication
(10) Pub. No.: US 2009/0207011 A1
(43) Pub. Date: Aug. 20, 2009

(54) Auto-charging alert device for rotatable pneumatic object

(76) Inventor: Hsug Fang Wang, Temple City, CA (US)

Correspondence Address: DAVID AND RAYMOND PATENT FIRM, 108 N. YNEZ AVE., SUITE 128, MONTEREY PARK, CA, 91754, US

(21) Appl. No.: 12/378,469

(22) Filed: Feb. 13, 2009

Related U.S. Application Data
(60) Provisional application No. 61/066,005, filed on Feb. 14, 2008.

(51) Int. Cl. B60C 23/02

(52) U.S. Cl. 340/448; 340/442; 116/34 R

(57) ABSTRACT

An auto-charging alert device for a rotatable pneumatic object includes an alert unit for generating a warning signal when an interior pressure of the rotatable pneumatic object is below a predetermined threshold, and an auto-charging unit which includes a charger housing and a charging arrangement. The charging arrangement includes an electric supply unit received in the charger housing and electrically connected with the power inlet of the alert unit, and a kinetic power generator received in the charger housing to electrically connect with the electric supply unit for converting a kinetic energy of the rotatable pneumatic object into electrical energy to be stored in the electric supply unit, such that the electric supply unit is automatically charged to supply adequate electricity to the alert unit for ensuring a proper and consistent operation of the alert unit.

### BACKGROUND OF THE PRESENT INVENTION

### CROSS REFERENCE OF RELATED APPLICATION

This is a regular application of a provisional application having an application No. 61/066,005 and a filing date of Feb. 14, 2008.

1. Field of Invention

The present invention relates to a rotatable pneumatic object, and more particularly to an auto-charging alert device for a rotatable pneumatic object so that the alert device can be automatically re-charged by the kinetic energy of the rotatable pneumatic object.

2. Description of Related Arts

A conventional alert device, such as the one disclosed in US Patent Application US 2003/0141969 to Wang, for a pneumatic object such as a tire for a vehicle comprises a signal arrangement comprising a cap, a signal generator received in the cap, and a power supply arrangement which comprises a first contact unit connected to the generator and a second contact unit. The alert device further comprises a connector which is adapted for mounting to a valve of a pneumatic object, and comprises a power inlet connect to the second contact unit of the power supply arrangement and a power outlet connected to the signal generator, wherein when the pneumatic object has a pneumatic pressure lower than a predetermined standard pressure, a warning signal will be generated for catching attention of the relevant personnel, such as the driver.

A major problem for this convention alert device is that in order to produce the warning signal, the alert device must be powered by an electricity source. One way of doing this is to install a battery (such as a rechargeable battery) into the alert device so as to provide energy for generating the warning signal. However, the battery needs replacing or recharging periodically for maintaining its consistent and reliable warning performance. The simplest strategy for accomplishing replacing or recharging the battery is to make the battery detachable from the alert device so that it can be replaced or recharged through a predetermined adaptor by a conventional AC power source. The problem for this is that the user of the alert device may need to detach and attach the battery from and to the alert device on the pneumatic object very frequently. If there is any technical carelessness on the part of the user in detaching or attaching the battery, the alert device may not function properly or may even affect the safety of the vehicle.

### SUMMARY OF THE PRESENT INVENTION

A main object of the present invention is to provide an auto-charging alert device for a rotatable pneumatic object, wherein the alert device can be automatically re-charged by the kinetic energy of the rotatable pneumatic object via the centrifugal force thereof. In other words, the alert device is self-charging for prolonging the service life span without manually replacing the power source.

Another object of the present invention is to provide an auto-charging alert device for a rotatable pneumatic object, wherein the auto-charging device is adapted to convert a kinetic energy of the rotatable pneumatic object to electrical energy for charging the rechargeable battery of the alert device. In other words, when the driver drives the vehicle, the rotatable pneumatic object, i.e. the wheel including the tire and rim, is rotated to generate the kinetic energy for charging the auto-charging alert device. Therefore, maintaining consistent and reliable electricity supply for the alert device in order to generate the warning is kept to be the simplest.

Another object of the present invention is to provide an auto-charging alert device for a rotatable pneumatic object, wherein the auto-charging device does not interfere with the normal operation of the alert device or the vehicle so as to maximize the safety performance of the present invention. Moreover, the present invention can be used in a wide variety of vehicles.

Another object of the present invention is to provide an auto-charging alert device for a rotatable pneumatic object, wherein both two perpendicular axes movements of two power generators are capable of support electricity toward the charging housing which is maximize the charging performance of the present invention.

Accordingly, in order to accomplish the above objects, the present invention provides an auto-charging alert device for a rotatable pneumatic object, comprising:

an alert unit which comprises a power inlet and a pressure sensor for detecting a pressure of the rotatable pneumatic object; and

an auto-charging unit comprising:

a charger housing adapted for mounting on the rotatable pneumatic object; and

a charging arrangement, which comprises:

an electric supply unit received in the charger housing and electrically connected with the power inlet of the alert unit; and

a kinetic power generator received in the charger housing to electrically connect with the electric supply unit for converting a kinetic energy of the rotatable pneumatic object into electrical energy to be stored in the electric supply unit, such that the electric supply unit is automatically charged to supply adequate electricity to the alert unit for ensuring a proper and consistent operation of the alert unit.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an auto-charging alert device according to a first preferred embodiment of the present invention.

FIG. 2 is a schematic diagram of the auto-charging alert device according to the above first preferred embodiment of the present invention.

FIG. 3 illustrates the kinetic power generator of the auto-charging alert device according to the above first preferred embodiment of the present invention.

FIG. 4 is a perspective view of the auto-charging alert device according to a second preferred embodiment of the present invention.

FIG. 5 is a schematic diagram of the auto-charging alert device according to the above second preferred embodiment of the present invention.

FIG. 6 is an alternative mode of the auto-charging alert device according to the above first preferred embodiment of the present invention.

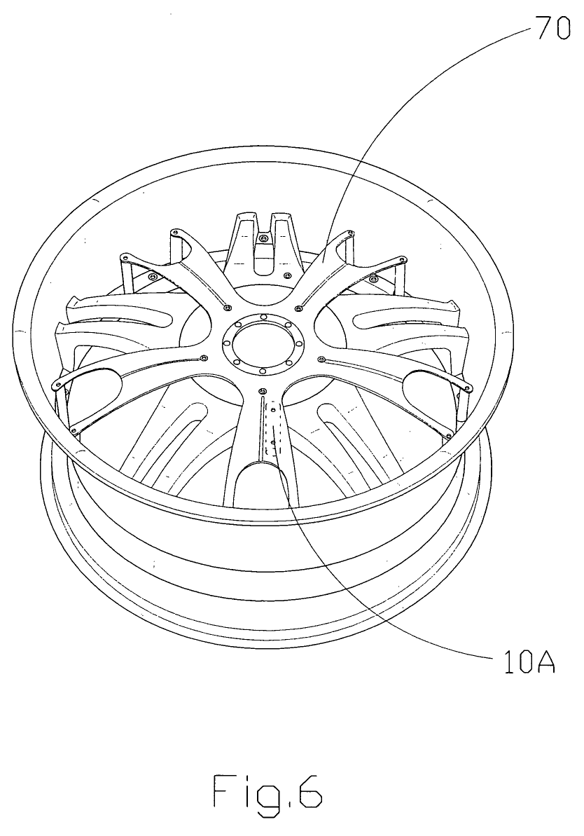

FIG. 7 is a sectional view of the alternative mode of the auto-charging alert device according to the above first preferred embodiment of the present invention.

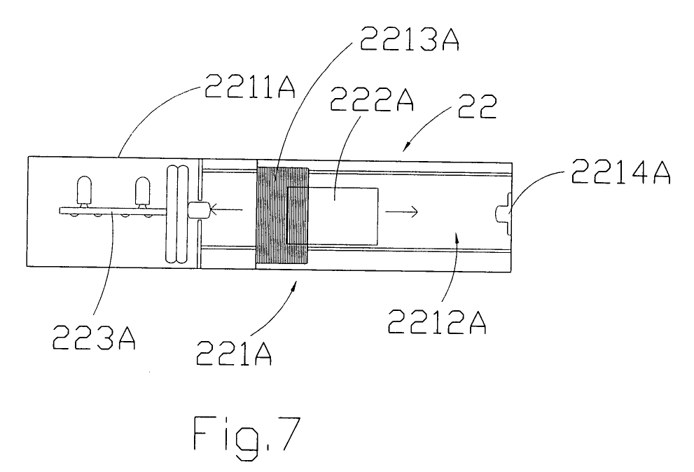

FIG. 8 is a second alternative mode of the auto-charging alert device according to the above first preferred embodiment of the present invention.

FIG. 9 is a sectional view of the second alternative mode of the auto-charging alert device according to the above first preferred embodiment of the present invention.

### DETAILED DESCRIPTION OF THE PREFERRED EMBODIMENT

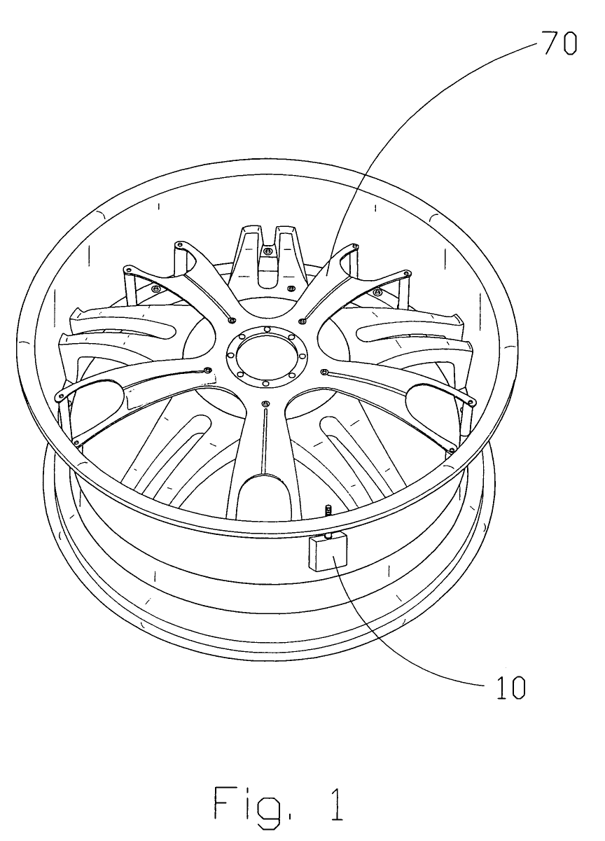

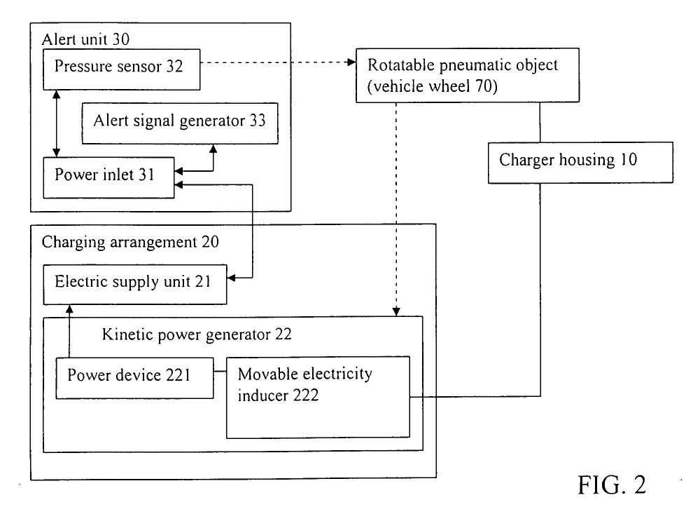

Referring to FIG. 1 to FIG. 2 of the drawings, a charging device for an auto-charging alert device for a rotatable pneumatic object is illustrated. The rotatable pneumatic object is illustrated as a vehicle wheel 70 comprising a rim and a tire mounted thereto, wherein the rotatable pneumatic object has an interior pressure maintained for operation.

According to the preferred embodiment, the auto-charging alert device comprises an alert unit 30 and an auto-charging unit. The alert unit 30 comprises a power inlet 31, a pressure sensor 32 for detecting the interior pressure of the rotatable pneumatic object, and an alert signal generator 33 for generating a warning signal when the interior pressure is below a predetermined threshold.

The auto-charging unit comprises a charger housing 10 adapted for mounting on the rotatable pneumatic object and a charging arrangement 20 for supplying electricity to the alert unit 30. Accordingly, the alert unit 30 can be also housed in the charger housing 10 to form an integrated housing body.

The charging arrangement 20 comprises an electric supply unit 21 received in the charger housing 10 and electrically connected with the power inlet 31 of the alert unit 30, and a kinetic power generator 22 received in the charger housing 10 to electrically connect with the electric supply unit 21 for converting a kinetic energy of the rotatable pneumatic object into electrical energy to be stored in the electric supply unit 21, such that the electric supply unit 21 is automatically charged to supply adequate electricity to the alert unit for ensuring a proper and consistent operation of the alert unit 10.

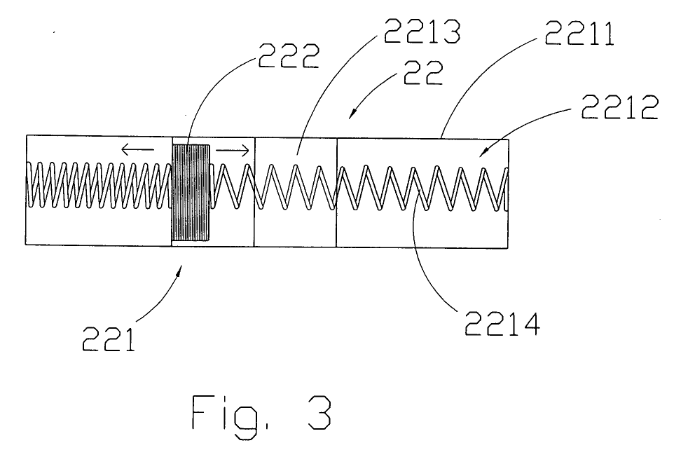

According to the preferred embodiment, the auto-charging alert device can be an internal alert device mounted at the interior surface of the rim within the tire as shown in FIG. 1, or can be an external alert device mounted to the valve of the vehicle wheel 70 as shown in FIG. 3.

As shown in FIG. 1, the auto-charging alert device is embodied as an internal alert device, wherein the charger housing 10 is mounted at the interior surface of the rim within the tire. The pressure sensor 32 is an electronic sensor for detecting the interior pressure of the rotatable pneumatic object.

The electric supply unit 21 comprises a rechargeable battery or a power capacitor for normally storing electricity supplied by the kinetic power generator 22 while adapted to discharge electricity to the alert unit 30 for generating the warning signal.

The kinetic power generator 22 comprises a power device 221 and a movable electricity inducer 222 movably provided in the charger housing 10 with respect to the power device 221, in such a manner that when the rotatable pneumatic object is driven to rotate, the movable electricity inducer 222 is driven to move accordingly to physically induce electricity generation at the power device 221. The electricity generated is supplied to the electric supply unit 21 for continuously recharging thereof so as to supply adequate electricity to the alert unit 30 for ensuring a proper and consistent operation of the alert unit 30. In other words, when the rotatable pneumatic object is rotating, such as rotation of a vehicle wheel 70, the charging arrangement 20 will be recharged continuously so as to allow the alert unit 30 to function properly and consistently without requiring detachment and attachment of the electric supply unit 21 or the alert unit 30.

According to the preferred embodiment, the power device 221 of the kinetic power generator 22 comprises a tubular housing 2211 defining an induction cavity 2212 and mounted to the rotatable pneumatic object, and a magnetic element 2213 winding provided on tubular housing 2211, as shown in FIG. 3, such that when an induction coil is traveling within the induction cavity 2212, electricity will be induced at the induction coil for being supplied to the electric supply unit 21. Thus, the movable electricity inducer 222 comprises an induction coil movably disposed within the induction cavity 2212 in such a manner that when the pneumatic object is rotating, the movable electricity inducer 222 is adapted to be driven to move within the induction cavity 2212 and repetitively across the magnetic element 2213 for electromagnetically inducing electricity at the induction coil.

The power device 221 further comprises a resilient element 2214 provided within the induction cavity 2212 to attach onto the movable electricity inducer 222 for physically restraining the moving path thereof within the induction cavity 2212, wherein the resilient element 2214 is arranged to normally apply an urging force to the movable electricity inducer 222 in the direction of the magnetic element 2213 so as to minimize unnecessary movement of the movable electricity inducer 222 within the induction cavity 2212 when it is driven to move therewithin.

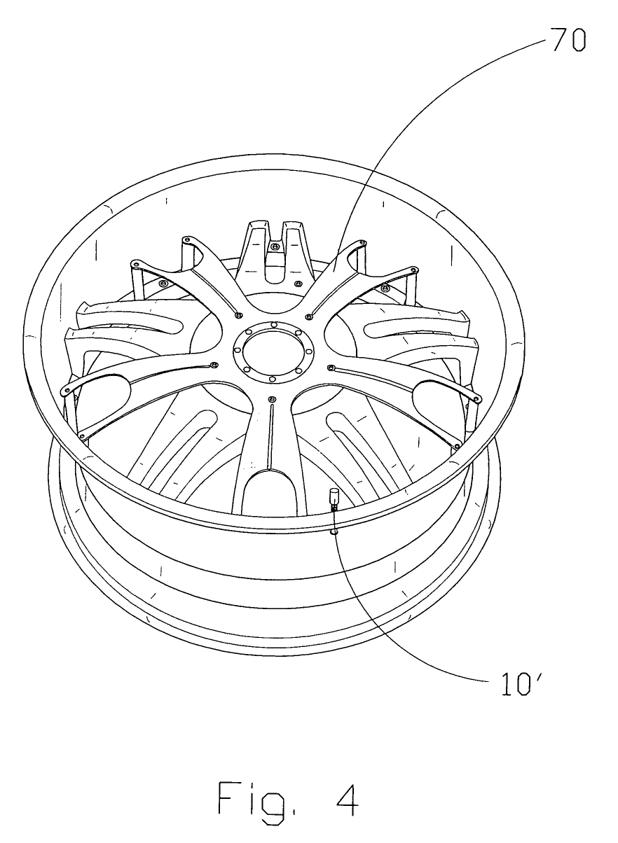

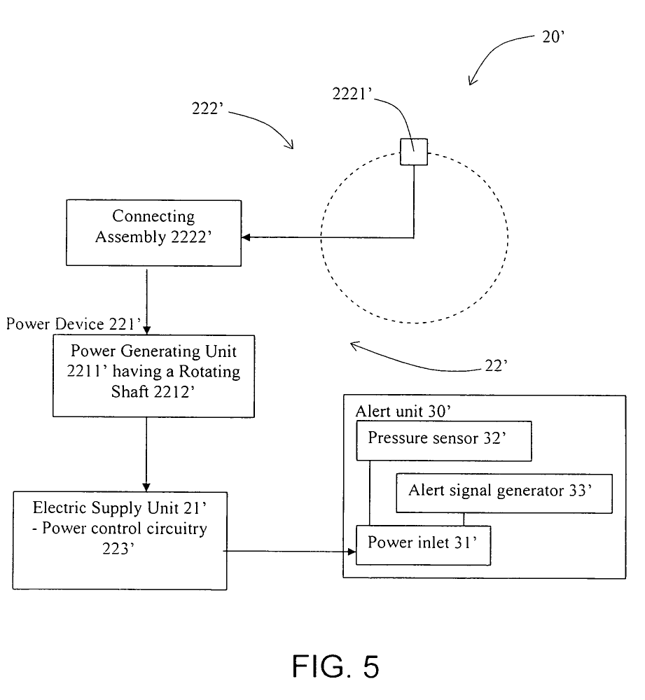

As shown in FIGS. 4 and 5, an auto-charging alert device of a second embodiment illustrates an alternative mode of the first embodiment. As shown in FIG. 3, the auto-charging alert device is embodied as an external alert device, wherein the charger housing 10′ is mounted at the valve of the vehicle wheel 70. The pressure sensor 32′ can be a pressure detection mechanism for detecting the interior pressure of the rotatable pneumatic object.

The charger housing 10′ is adapted for mounting on the pneumatic object to electrically connect with the power inlet 31′ of the alert unit 30′. On the other hand, the charging arrangement 20′ comprises an electric supply unit 21′ and a kinetic power generator 22′. The electric supply unit 21′ and the kinetic power generator 22′ are received in the charger housing 10′ for electrically connecting with the power inlet 31′ of the alert unit 30′.

The kinetic power generator 22′ is received in the charger housing 10 to electrically connect with the electric supply unit 21′ for providing electrical energy thereto, wherein the kinetic power generator 22′ comprises a power device 221′ and a movable electricity inducer 222′ movably provided in the charger housing 10′ with respect to the power device 221′, in such a manner that when the rotatable pneumatic object is driven to rotate, the movable electricity inducer 222′ is driven to move accordingly to physically induce electricity generation at the power device 221′, wherein the electricity generated is supplied to the electric supply unit 21′ for continuously recharging thereof so as to supply adequate electricity to the alert unit 30′ for ensuring a proper and consistent operation of the alert unit 30′. In other words, when the pneumatic object is rotating, such as rotation of a vehicle tire, the charging arrangement 20′ will be recharged continuously so as to allow the alert unit 30′ to function properly and consistently without requiring detachment and attachment of the electric supply unit 21′ or the alert unit 30′.

According to the preferred embodiment of the present invention, the power device 221′ is adapted to generate electrical power when it is mechanically actuated (usually by rotational force) by the movable electricity inducer 222′. More specifically, the power device 221′ comprises a power generating unit 2211′ and a rotating shaft 2212′ extended from the power generating unit 2211′ in such a manner that when the rotating shaft 2212′ is driven to rotate, the power generating unit 2211′ is mechanically actuated to generate electricity for the electric supply unit 21′. Accordingly, the moveable electricity inducer 222′ comprises a kinetic body 2221′ and a connecting assembly 2222′ connecting the kinetic body 2221′ with the rotating shaft 2212 of the power device 221, wherein the kinetic body 2221′ is adapted to travel a circular path within the charging housing 10′ for driving the rotating shaft 22121′ to rotate via the connecting assembly 2222′. Thus, when the rotatable pneumatic object, such as the vehicle wheel 70, is rotating (i.e. when the vehicle is moving forward or backward), the kinetic body 2221′ is subject to a centrifugal force through the rotation of the rotatable pneumatic object so as to be driven to travel a circular path within the charger housing 10′. As a result, when the kinetic body 2221′ is driven to move in a circular path, it will drive the rotating shaft 2212′ to rotate as well via the connecting assembly 2222′ so as to actuate the power generating unit 2211′ to generate electricity for supplying to the electric supply unit 21′.

It is worth mentioning that the connecting assembly 2222′ may comprises a connecting shaft connecting the rotating shaft 2212′ with the kinetic body 2221′ so that when the kinetic body 2221′ is driven to travel a circular path, the rotating shaft 2212 is also driven to rotate for rotating the rotating shaft 2212′ of the power device 22′. The connecting assembly 2222′ may further comprise a gear assembly provided within the charger housing 10′ for mechanically changing a rotational speed of the rotating shaft 2212′ with respective to the angular velocity of the kinetic body 2221′. In other words, the moveable electricity inducer 222′ likes an automatic hand crank device that when the kinetic body 2221′ is driven by the centrifugal force of the rotatable pneumatic object, the electric supply unit 21′ will be automatically charged.

The electric supply unit 21′ can comprise a rechargeable battery or a power capacitor for normally storing electricity supplied by the kinetic power generator 22′ while adapted to discharge electricity to the alert unit 30′ for generating the warning signal by the alert unit 30′.

In order to enhance the power supplying performance of the charging device of the present invention, the kinetic power generator 22′ further comprises a power control circuitry 223′ provided in the charger housing 10 to electrically connect with the power device 221′ so as to optimally control the electricity generated by the power device 221′ and supplied to the electric supply unit 21′.

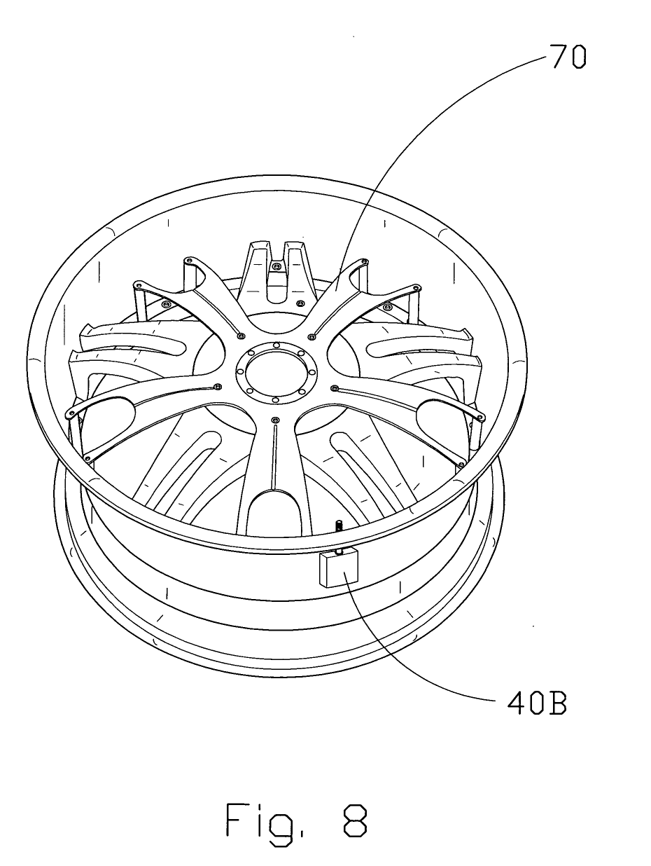

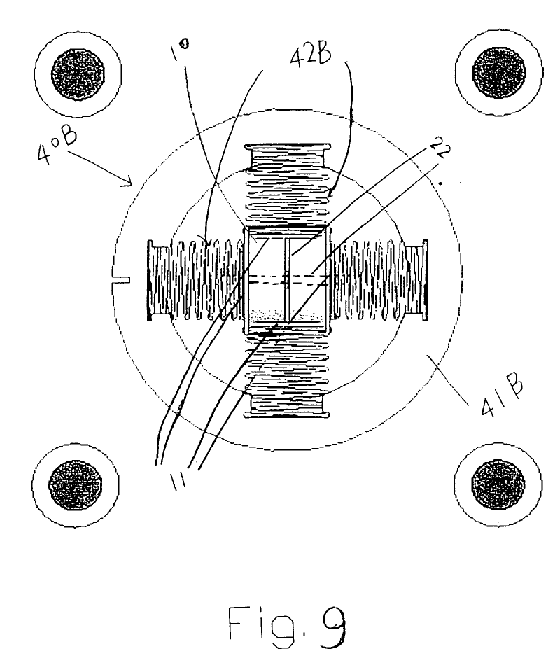

Referring to FIG. 8 to FIG. 9 of the drawings, a second alternative mode of the charging device according to the first preferred embodiment of the present invention is illustrated, wherein the auto-charging unit further comprises a resilient arrangement 40B coupling with the charger housing 10 having four sidewalls 11.

Accordingly, the resilient arrangement 40B comprises a casing 41B receiving the charger housing 10 therein and two pairs of resilient units 42B biasing between the casing 41B and the charger housing 10 for applying a spring force thereto with respect to the casing 41B.

According to a second alternative embodiment as shown in FIG. 9, the casing 41B can be formed in the ring shape. And the charging housing 10 comprises two kinetic power generators 22 perpendicular to each other to discharge electricity to the alert unit 30 for generating the warning signal. Each of the power generators 22 are aligned with the resilient units 42B such that each direction of the power generators 22 are capable of supporting electricity to the alert unit for ensuring a proper and consistent operation of the alert unit 10. In other words, both two perpendicular axes movements of two power generators are capable of support electricity toward the charging housing which is maximize the charging performance of the present invention.

It is worth mentioning that the magnetic element 2213 is fixed within the induction cavity 2212 while the induction coil of the electricity inducer 222 is moving within the induction cavity 2212 such that the electricity inducer 222 is adapted to be driven to move within the induction cavity 2212 and repetitively across the magnetic element 2213 for electromagnetically inducing electricity at the induction coil. Likewise, the magnetic element 2213 can move within the induction cavity 2212 while the induction coil of the electricity inducer 222 can be fixed within the induction cavity 2212 such that the magnetic element 2213 is adapted to be driven to move within the induction cavity 2212 and repetitively through the electricity inducer 222 for electromagnetically inducing electricity at the induction coil. It is worth mentioning that both the magnetic element 2213 and the induction coil of the electricity inducer 222 can move within the induction cavity 2212 at a corresponding opposite direction such that the magnetic element 2213 and the induction coil of the electricity inducer 222 are adapted to be driven to move corresponding with each other and repetitively through the each other for electromagnetically inducing electricity at the induction coil.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An auto-charging alert device for a rotatable pneumatic object, comprising:
an alert unit comprises a power inlet, a pressure sensor for detecting an interior pressure of the rotatable pneumatic object, and an alert signal generator adapted for generating a warning signal when the interior pressure of the rotatable pneumatic object is below a predetermined threshold; and
an auto-charging unit comprising a charger housing adapted for mounting on the rotatable pneumatic object and a charging arrangement supplying electricity to said alert unit, wherein said alert unit is housed in said charger housing to form an integrated housing body, wherein said charging arrangement comprises an electric supply unit received in said charger housing and electrically connected with said power inlet of said alert unit, and a kinetic power generator received in said charger housing to electrically connect with said electric supply unit for converting a kinetic energy of the rotatable pneumatic object into electrical energy to be stored in said electric supply unit, so as to automatically charge said electric supply unit to supply adequate electricity to said alert unit for ensuring a proper and consistent operation of said alert unit.

2. The auto-charging alert device, as recited in claim 1, wherein said charger housing is constructed for mounting at an interior surface of a rim within a tire, and said pressure sensor is an electronic sensor for detecting the interior pressure of the rotatable pneumatic object.

3. The auto-charging alert device, as recited in claim 2, wherein said electric supply unit is selected from a group consisting of a rechargeable battery and a power capacitor which normally stores electricity supplied by said kinetic power generator and discharges electricity to said alert unit for generating the warning signal.

4. The auto-charging alert device, as recited in claim 3, wherein said kinetic power generator comprises a power device and a movable electricity inducer movably provided in said charger housing with respect to said power device, wherein when said rotatable pneumatic object is driven to rotate, said movable electricity inducer is driven to move accordingly to physically induce electricity generation at said power device.

5. The auto-charging alert device, as recited in claim 4, wherein said power device of said kinetic power generator comprises a tubular housing defining an induction cavity and being adapted for mounting to the rotatable pneumatic object, and an magnetic element winding provided on said tubular housing, wherein said movable electricity inducer comprises an induction coil movably disposed within said induction cavity, wherein when said induction coil is traveling within said induction cavity, electricity is induced at said induction coil for being supplied to said electric supply unit.

6. The auto-charging alert device, as recited in claim 5, wherein said power device further comprises a resilient element provided within said induction cavity to attach onto said movable electricity inducer for physically restraining a moving path thereof within said induction cavity, wherein said resilient element is arranged to normally apply an urging force to said movable electricity inducer in the direction of said magnetic element so as to minimize unnecessary movement of said movable electricity inducer within said induction cavity when it is driven to move therewithin.

7. The auto-charging alert device, as recited in claim 1, wherein said auto-charging alert device is an external alert device and said charger housing is arranged for mounting at a valve of said vehicle wheel, wherein said pressure sensor is a pressure detection mechanism for detecting the interior pressure of the rotatable pneumatic object.

8. The auto-charging alert device, as recited in claim 7, wherein said kinetic power generator comprises a power device and a movable electricity inducer movably provided in said charger housing with respect to said power device, wherein when said rotatable pneumatic object is driven to rotate, said movable electricity inducer is driven to move accordingly to physically induce electricity generation at said power device.

9. The auto-charging alert device, as recited in claim 8, wherein the moveable electricity inducer comprises a kinetic body and a connecting assembly connecting said kinetic body with a rotating shaft of said power device, wherein said kinetic body is adapted to travel a circular path within said charging housing for driving said rotating shaft to rotate via said connecting assembly, wherein when said kinetic body is driven to move in a circular path, said rotating shaft is driven to rotate as well via said connecting assembly so as to actuate said power generating unit to generate electricity for supplying to said electric supply unit.

10. The auto-charging alert device, as recited in claim 9, wherein said power device of said kinetic power generator comprises a tubular housing defining an induction cavity and being adapted for mounting to the rotatable pneumatic object, and an magnetic element winding provided on said tubular housing, wherein said movable electricity inducer comprises an induction coil movably disposed within said induction cavity, wherein when said induction coil is traveling within said induction cavity, electricity is induced at said induction coil for being supplied to said electric supply unit.

11. The auto-charging alert device, as recited in claim 10, wherein said kinetic power generator further comprises a power control circuitry provided in said charger housing to electrically connect with said power device so as to optimally control the electricity generated by said power device and supplied to said electric supply unit.

12. The auto-charging alert device, as recited in claim 11, wherein Buffering rubbers are provided at two ends of said induction cavity for preventing said movable electricity inducer from directly hitting the sidewalls of said induction cavity.

13. The auto-charging alert device, as recited in claim 4, wherein said auto-charging unit further comprises a resilient arrangement coupling with said charger housing having four sidewalls.

14. The auto-charging alert device, as recited in claim 13, wherein said resilient arrangement comprises a casing receiving said charger housing therein and two pairs of resilient units biasing between said casing and said charger housing for applying a spring force thereto with respect to said casing.

15. The auto-charging alert device, as recited in claim 14, wherein said charging housing comprises two kinetic power generators, each of which is aligned with said resilient units such that each direction of said power generators is capable of supporting electricity to said alert unit for ensuring a proper and consistent operation of said alert unit.

16. The auto-charging alert device, as recited in claim 15, wherein said magnetic element is affixed within said induction cavity while said induction coil of said electricity inducer is moving within said induction cavity, wherein said electricity inducer is adapted to be driven to move within said induction cavity and repetitively across said magnetic element for electromagnetically inducing electricity at said induction coil.

17. The auto-charging alert device, as recited in claim 15, wherein said magnetic element moves within said induction cavity while said induction coil of said electricity inducer is affixed within said induction cavity, wherein said magnetic element is adapted to be driven to move within said induction cavity and repetitively through said electricity inducer for electromagnetically inducing electricity at said induction coil.

18. The auto-charging alert device, as recited in claim 15, wherein said magnetic element and said induction coil of said electricity inducer move within said induction cavity at a corresponding opposite direction, wherein said magnetic element and said induction coil of said electricity inducer are adapted to be driven to move corresponding with each other and repetitively through the each other for electromagnetically inducing electricity at said induction coil.
